(19) United States
(12) Patent Application Publication
(10) Pub. No.: US 2026/0104310 A1
(43) Pub. Date: Apr. 16, 2026

(54) System and Method for Monitoring Structural Changes

(71) Applicant: DAYTON DIGITAL LLC, CAPE CORAL, FL (US)

(72) Inventors: KENNETH PAWLINE, WESTAMPTON, NJ (US); IAN M SUMMERS, WESTAMPTON, NJ (US); TODD ZIELINSKI, PHILADELPHIA, PA (US); CRAIG STONEKING, MARLTON, NJ (US); AARON AKIVA RUBIN, Philadelphia, PA (US); ZACHARY SAMALONIS, Philadelphia, PA (US); ERIC SCHNEIDER, Philadelphia, PA (US)

(73) Assignee: DAYTON DIGITAL LLC, CAPE CORAL, FL (US)

(21) Appl. No.: 19/120,781

(22) PCT Filed: Oct. 14, 2023
(86) PCT No.: PCT/US2023/076925

§ 371 Date: Apr. 13, 2025

Related U.S. Application Data
(60) Provisional application No. 63/416,314, filed on Oct. 14, 2022.

(51) Int. Cl. G01M 5/00; G01D 5/14; G01D 18/00; G01P 15/18

(52) U.S. Cl. CPC G01M 5/0066; G01D 5/145; G01D 18/00; G01P 15/18

(57) ABSTRACT

A system and method of monitoring changes in a structure using a deformation gauge capable of measuring changes in position in three dimensions and communicating wirelessly with an external device. The deformation gauge features a plurality of magnetic field sensors that are capable of detecting changes in the magnetic field experienced by the sensors and produced by a magnet housed separately and positioned on a structure a predetermined distance from the sensors. Optionally, a tilt gauge with one or more high or low precision accelerometers can be used to detect any change in the orientation of the tilt gauge can be detected and measured in three dimensions. Another version of the system includes a high and/or a low-frequency microphone coupled with a target magnet suspended in three dimensions from a dampening element that can be used on a structure on or the ground to detect and analyze seismic activity.

### CROSS-REFERENCE TO RELATED APPLICATIONS

This application claims the benefit of priority to U.S. Provisional Application No. 63/416,314 filed on Oct. 14, 2022. The content of U.S. Provisional Application No. 63/416,314 filed on Oct. 14, 2022 is incorporated by reference in its entirety. This application claims the benefit of priority to PCT Application No. PCT/US2023/076925 filed on Oct. 14, 2023. The content of PCT Application No. PCT/US2023/076925 filed on Oct. 14, 2023 is incorporated by reference in its entirety.

### TECHNICAL FIELD

The present disclosure is in the technical field of engineering and/or construction equipment. More particularly, the present disclosure relates to a system for remotely monitoring changes to a defect in a structure such as a gap, crack or break.

### BACKGROUND ART

Engineers have developed tools that help them monitor the condition of a structure over time. This can be useful in a variety of contexts in which it is important to monitor damage to a building or other structure over time or during a particular event or series of events. For example, people performing construction, repair or demolition work on or near a wall or other structure that has a crack in it may need to monitor the condition of that crack while performing work on or near that wall or structure to detect if the crack is getting any worse while they are working. Similarly, if they are trying to repair the crack in the wall, they will need to monitor the condition of the crack while they are working. Likewise, a number of structures need to be monitored over long periods of time, such as bridges. Currently, divers need to be sent underwater to assess and measure ongoing damage to bridges to monitor their safety and to plan repairs and maintenance. As a result, the field needs a device or system that can be used to monitor the condition of a bridge remotely over time.

A deformation gauge is a tool that is typically used to measure or monitor changes in cracks in the foundation, walls or masonry of a structure. For example, devices sometimes referred to as “string-pot” gauges, use a wire rope attached to a moveable object, like a portion of a wall on one side of a crack. The rest of the device is placed on the other side of the crack and is able to measure the amount of tension or slack in the wire rope. Movement in the wire rope can be detected by a number of conventional devices based upon the movement of the wire rope relative to the rest of the device. However, this type of device does not break the movement of the wall into x, y and z vectors, but rather produces one total measurement of movement in all three directions. As a result, the measurements produced by this device are rather imprecise.

Another type of deformation gauge involves attaching two pieces of overlapping Plexiglas or a similar translucent material to either side of a crack in a wall. The plexiglass is printed with a scale or other means to detect movement between the two pieces of plexiglass. When the crack moves, the plexiglass pieces move relative to one another and produce a reading that can be manually taken. This type of gauge can detect movement in two planes, but not three and requires a technician to manually examine the gauge in order to take readings from it. These readings are subject to human error and the two pieces of plexiglass can produce a parallax effect that interferes with accurate measurements.

There are other devices on the market that do not make up for the shortcomings listed above. For example, hydraulic strain gauges are designed much like a typical syringe. A larger piston is connected to the object that may produce movement, that movement causes fluid to move from a larger tube into a smaller tube where the pressure exerted can be measured, perhaps by a Bourdon tube. These devices work well to detect very small movements, but do not serve to detect movement between two different structures.

There is a strong need in the engineering field for an apparatus and method of using same that will allow someone to measure the movement of a structure near a defect in a wall or other structure in three dimensions and that can communicate data to a remote user or device.

### SUMMARY OF THE INVENTION

### Technical Problem

The present invention is a method of monitoring changes or movement in a structure. More specifically, the present disclosure details equipment and a method of using that equipment to monitor changes in position between multiple structures or parts of the same structure in three dimensions. More specifically, the inventor has developed a novel deformation gauge to monitor changes in a physical structure over time. The deformation gauge used in this method is capable of resolving movement in a structure in three dimensions rather than just one or two. In addition, it does not require a technician to physically view the deformation gauge in order to take readings from it. Furthermore, the deformation gauge is able to upload readings to a separate device or store the readings on an internal storage device to preserve them even if the gauge itself fails or loses power. The method can optionally involve the use of a tilt gauge to augment the readings taken with the deformation gauge.

### Definitions

Substantially-Substantially in this disclosure means within 10 degrees or 10 percent of the stated measurement or orientation.

Features means the stated structure includes, is attached to integrated into, on or physically in contact with another structure.

### Solution to the Problem

Preferred embodiments and the inventor's anticipated best mode of the deformation gauge described herein has two discrete parts-a target and a sensor array. The target includes a magnet, preferably contained in a housing, made of a material that does not interfere with the magnet's magnetic field. The sensor array includes a circuit board featuring a plurality of magnetic field sensors (e.g., Hall effect sensors) capable of sensing changes in a magnetic field, also preferably contained within a housing or body. The sensor array is used to sample the magnet's magnetic field from multiple positions to accurately determine the position of the sensor array with respect to the target magnet in three dimensions.

The Hall Effect is the production of a potential difference or voltage in a conductor having current applied to it at the same time the conductor is exposed to a magnetic field. Generally, the effect is greatest when the magnetic field is perpendicular to the flow of charge or current in the conductor. As current moves through the conductor, generally a semiconductor, it is exposed to a magnetic field which deflects the charge carriers enough to create a potential difference. The change in voltage is a direct function of and can be used to determine the strength and direction of the source of the magnetic field. When the strength of the magnetic field produced by the magnet is already known and the starting position of the magnet relative to the sensor(s) is already known, the measurements from a Halls Effect sensor can be used to measure the change in position between the sensor and the magnet. Repeated measurements of the change in voltage can be used to “map” or analyze a magnetic field at different points with respect to the magnet and the sensor. These data can be used to detect changes in the magnetic field which typically result if there is some change in position or movement between the magnet and the conductor. Thus, when the target moves in relation to the sensor, or vice versa, the change in voltage detected by the three Halls effect sensors can be used to calculate the distance and direction of that movement. This phenomenon can be used to monitor the physical location and thus condition of a physical structure such as a support beam, piling or wall over time. It can also be used to measure vibrations or subtle movements in naturally occurring structures and formations. These field sensors use the Hall effect to detect the change in stimulated current though a coil operably connected to silicon. Different orientation of the coils in the sensor provide different axes of measurement. Multiple magnetic sensors oriented in different planes, can be used to detect and calculate movement between the sensor and the target magnet in multiple dimensions.

The Halls Effect or “magnetic field” sensors are each able to detect changes in the position of the sensor array and thus the deformation gauge, in three dimensions and relay that data to a microprocessor that processes and filters the data to produce positional data that describes the location of the target magnet and any change in position between the target magnet and the sensor array.

The accuracy of the Hall-effect sensor measurements can be affected by their positioning. Preferred embodiments of the device include a sensor array that includes three Hall-effect sensors positioned on a programmed circuit board so that all three sensors are positioned in a single plane. More accurate measurements can be made by the sensors if that plane is positioned perpendicularly or substantially perpendicularly to the polar axis of the magnet featured by the target, i.e. the target magnet. Accuracy can be further improved when the polar axis of the magnet also intersects the plane at the center of the triangle the sensors form.

When the gauge is manufactured, the magnetic field is “mapped” or measured at various points in space around the magnet. The higher the resolution, i.e. the more points of the magnetic field that are mapped, the more accurate the measurements produced through the use of the device. Knowing the shape of the magnetic field allows for the creation of a table that displays the interpolated values between the measured points of the magnetic field.

When the device is in use, the magnetic sensors take multiple measurements of the magnetic field in three dimensions—the x, y and z axes¹. Individual measurement readings from the sensors are subject to a certain level of error. The sensor itself has an inherent level of error/noise. Additional noise may come from transient environmental factors. As a result, instead of taking a single measurement, the magnetic field sensors take hundreds of measurements in a fraction of a second and then average these ¹ Either multiple sensors capable of sensing a magnetic field in a single axis or dimension are used in combination and/or individual sensors each capable of measuring in three axes/dimensions are used in tandem. measurements—thereby reducing the error or noise that may be present in a single or a small number of measurements. The measurements are sampled by an analog to digital converter, then communicated digitally to a microprocessor. The values generated are then compared to the information produced when the magnet's magnetic field was originally mapped to produce a position of the magnet in a coordinate system shared by the magnetic field sensors. This measurement is then compared to initial measurements to reveal a change in the position of the magnet in the target relative to the magnetic field sensors indicating some sort of movement has taken place between the target and the sensor housing. The measurements can then be transmitted to a separate processor or receiver that is capable of storing and/or displaying the data. In this manner, the data that is collected and calculated by the deformation gauge is safely stored in another location if the deformation gauge loses power or is damaged. Other versions of the device include internal memory storage to store the same data in case of a power failure or other problem that prevents the data from being transmitted.

Before the device is put into use, the optimal range between the target magnet and the sensor array is calculated. If the sensor array is positioned too close to the target magnet, the Hall effect sensors become saturated with the magnetic field from the target magnet, rendering them unable to detect changes in that magnetic field. If the target magnet is too far away from the sensor array, then the readings produced by the magnetic field sensors will not be accurate. Using a process similar to the original mapping procedure, the optimal distance between the target magnet and the magnetic field sensor array is calculated. The magnetic field sensors are positioned and the distance from each sensor to the magnet is estimated using the formula below. The measurements are repeated over a range of temperature and time to characterize the change in magnetic field due to those factors. Then a mathematical model is created representing the field over physical location, time, and temperature. Using the known spatial relationship between the sensors and an initial estimate of the position of the target magnet, a gradient descent algorithm is used to find the magnet position that best satisfies the distance estimates.

$$Distance = ( f * r ) / 2. \\ where : \\ m = sqrt ( m x 2 + m y 2 + mz 2 ) \\ k = m * 3. / 2000. \\ r = m 0.25 / k \\ f = 8.0 - ( 0.93 * sqrt ( r ) )$$

As a result, in use, the sensor housing is placed at a calculated distance away from the target.

The effective distance of the system can be increased or decreased by using magnets with varying field strength. The size of the MEMs element, the better the characterization of the performance over temperature, the sensitivity of the capacitive measurement, the better the temperature correction curve—the better the resolution and precision of the measurement.

In use, the brackets for each component of the deformation gauge are installed on a surface being monitored before the actual components are attached to the brackets. First, the desired mounting distance for the installation is determined. The user identifies a crack or gap in a structure that needs to be monitored. The user determines the spacing of the components by measuring the width of the crack or gap and adding a preset distance to that measurement based upon the optimal position for the target magnet as detailed above.

The sensor bracket includes a sliding structure or tongue that is attached to both the sensor bracket as well as the target bracket. Once the distance between the target bracket and the sensor bracket is determined, the tongue that is slidably engaged with the sensor bracket and is attached to the target bracket at one end, can be extended to the desired length, thereby setting the position of the sensor and target relative to one another. The tongue is then temporarily clamped in place via two small screws that tighten a floating plastic tab against the tongue on the sensor bracket. Once the adhesive is cured or the brackets are otherwise firmly mounted, the tongue can be released and retracted back into the sensor bracket's body. The user will then attach the brackets to the structure featuring the crack/deformation using conventional adhesives. The sensor housing and target housings are then mounted on their respective brackets, perhaps by conventional fasteners such as screws. Once the sensor housing and target housing are firmly attached to their respective brackets, the gauge is ready to use to monitor movement of the wall on either side of the crack.

This method can be augmented through the use of a tilt gauge. A tilt gauge uses one or more MEMS accelerometers to measure the acceleration due to gravity in three directions allowing the device to detect any changes in “tilt” or the orientation of a structure in relation to a source of gravity—the Earth. Whereas the deformation gauge measures movement of the target magnet with respect to the sensor array, the tilt gauge measures movement of the accelerometer(s) relative to gravity. These two data sets can be combined to make very precise and very accurate measurements of the movement of an object or objects to which they are attached. The process for sampling and filtering/processing the data from the accelerometers is roughly the same as that described above for the magnetic field sensors. The accelerometer(s) take hundreds of measurements in a fraction of a second and then average these measurements-thereby reducing the error or noise that may be present in a single or a small number of measurements. The measurements are sampled by an analog to digital converter, then communicated digitally to a microprocessor. The processor is software enabled and configured to interpret the data from the accelerometers, magnetic field sensors and any other components to (a) account for and subtract out error and (b) calculate the position of the relevant sensors with respect to either the target magnet or the Earth's gravitational field, i.e. the ground.

The Tilt gauge can use more than one accelerometer, a combination of accelerometers and gyroscopes and/or a combination of low and high-precision accelerometers. One or more lower-precision accelerometers can be used to sample in tandem with the high-precision accelerometer(s) to detect and thereby filter superfluous higher frequency vibrations from the Hall-effect sensors and the high-precision accelerometer(s) and/or any other system components.

Initial embodiments of the system used a deformation gauge that was physically separate from the tilt gauge. Newer versions of the system include a single device or housing that includes both the sensor array and target of the deformation gauge as well as the accelerometer(s) of the tilt gauge.

Mems accelerometers and hall-effect sensors typically use components the performance of which is affected by temperature changes. When the external temperature changes, the characteristic frequency and scale factor of the sensing elements shift and cause measurement error. This system has applications that involve the system components being placed in extreme conditions.

In addition, temperature has an effect on the strength of a magnetic field. When a magnet's temperature is decreased the magnetic field that it creates becomes stronger and when its temperature is increased, its field becomes weaker up until the point where the magnet is heated enough that it loses its magnetic properties. The degree to which a change in temperature affects the magnetic field strength of a magnet of known composition can be calculated.

As a result, some versions of the system will include one or more temperature sensors operably connected to the hall-effect sensors, the mems accelerometers and/or other components of the system. The “noise” or change in magnetic field strength as a result of temperature can thus be calculated and subtracted out of the measurements made by the magnetic field sensors.

Other variations of the system are specifically configured to detect vibrations and can be used to monitor seismic activity. In some of these applications, the target magnet is suspended from or supported by a spring and/or other damping mechanism in three-dimensions, allowing for more delicate movements to be detected. Still other applications will include a low-frequency microphone that detects additional reference data of frequencies generated in the appropriate bandpass range. The system can be used on or in the ground to detect seismic vibrations or on a structure such as a building to detect how the vibrations from the seismic activity cause the building to vibrate. Since one or more of the system components (magnetic sensors, accelerometer(s), target magnet, . . . ) are suspended from a mounting spring and/or other dampening element and vibrate independently of the housing, they are effectively a low mass weight that detects vibrations of the overall unit. These frequencies can be used to then filter the seismic vibrations as noise in the displacement measurement, and as a separate frequency band of motion of the entire reference frame that the sensor and target are attached to. The data from the accelerometer and magnetic sensor array can be bandpass filtered to remove lower frequency changes in position in favor of data from higher frequency movements to detect and analyze short-frequency seismographic vibrations resulting from changes in position with respect to the accelerometer(s) and/or magnetic sensor array. If the microphone is coupled with the enclosure through a pressure vent, it can also detect air pressure variations that would occur during a seismic event.

These devices are capable of communicating wirelessly with a third device or set of devices that include the means to process the information from the gauges and present it to an end user as well as store the information for later retrieval. Some applications may use a wireless modulation technique such as LoRa to transmit data. As a result, the inventor has created a system or method of using a novel deformation gauge, optionally in conjunction with a tilt gauge-either separate or integrated therein, to monitor a change in the position of a structure over time. The system produces more accurate data than prior devices and methods and does so with a minimum of human intervention.

### Advantageous Effects of the Invention

In broad embodiment, the present invention is a system for monitoring the condition of a structure remotely. The advantages of the present invention include, without limitation, the ability to remotely monitor changes in a crack or gap in a structure over time or in response to specific events without having to have line of sight to the gauge or having a technician available to physically examine the gauge. Moreover, the present method allows a user to monitor the changes in a crack or gap or the movement of structures in three dimensions rather than just one or two. Furthermore, the inventive method also incorporates a tilt meter to allow the user to measure not only changes in a gap in a structure, but the orientation of the structure relative to the ground. Engineers and technicians working on a building, wall or bridge can remotely monitor the effects their work has on a gap or crack in a structure and/or the tilt or movement of the structure in three dimensions. In addition, versions of this system can be used to detect vibrations and thus can serve as a seismograph, calculating the changes in position of the sensors due to the vibrations caused by seismic events and then relaying the data to another component/location.

### BRIEF DESCRIPTION OF THE DRAWINGS

FIG. 1 is a perspective view of a deformation gauge as used in a first embodiment of the system;

FIG. 2A is a perspective view thereof with half of the cover or housing removed;

FIG. 2B is a perspective view of the target housing with the magnet removed;

FIG. 2C is a cross sectional view of the target;

FIG. 3 is a top plan view of the circuit board featuring the hall effect sensors;

FIG. 4A is a side cross-sectional view of the target housing and the sensor housing cut along the line B-B shown in FIG. 4B;

FIG. 4B is a top plan view thereof;

FIG. 4C is top cross-sectional view thereof;

FIG. 4D is a side plan view thereof;

FIG. 5A shows a perspective view of a tilt gauge that can be integrated into the other embodiments described herein;

FIG. 5B shows the same tilt gauge with the cover removed to expose the inner components;

FIG. 6A is a perspective view of the gauge used in a second embodiment of the system configured to detect temperature variations;

FIG. 6B is a top perspective view of the internal components thereof;

FIG. 7A is a perspective view of the gauge used in another embodiment of the system configured to detect seismic activity;

FIG. 7B is a top perspective view of the internal components thereof;

FIG. 8 is a rear perspective view of the deformation gauge as used in the first embodiment of the system; and

FIG. 9 is a perspective view of the deformation gauge installed near a structural in a wall;

FIG. 10 illustrates a hardware block diagram of a computing device 600 that may perform functions associated with operations discussed herein.

### DESCRIPTION OF EMBODIMENTS

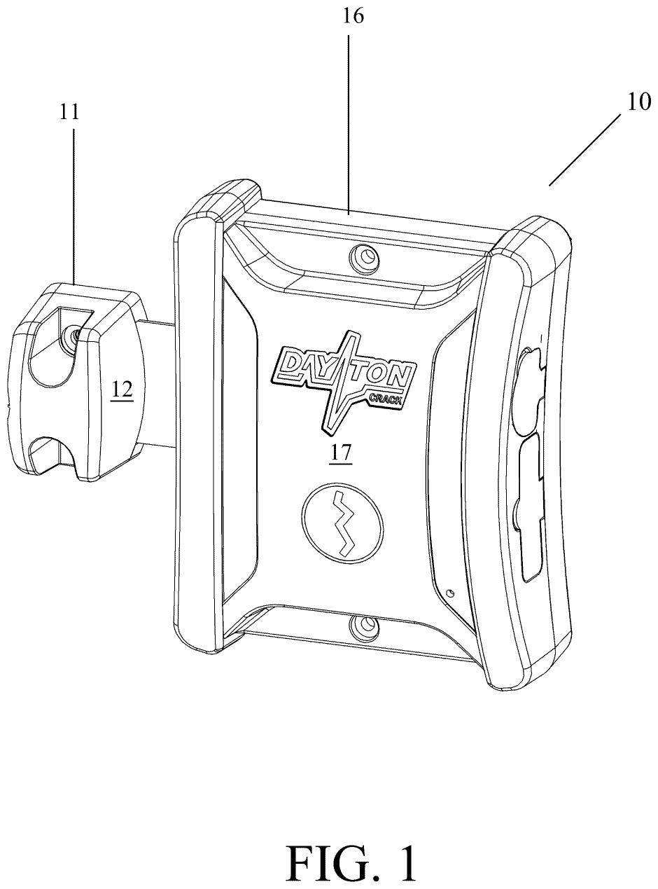

FIG. 1 shows the deformation gauge, generally 10. As discussed above, the deformation gauge 10 has two basic components—the target 11 and the sensor 16. The target 11 is a housing or casing 12 that encloses a target magnet. The sensor housing 17 contains the rest of the components of the gauge 10.

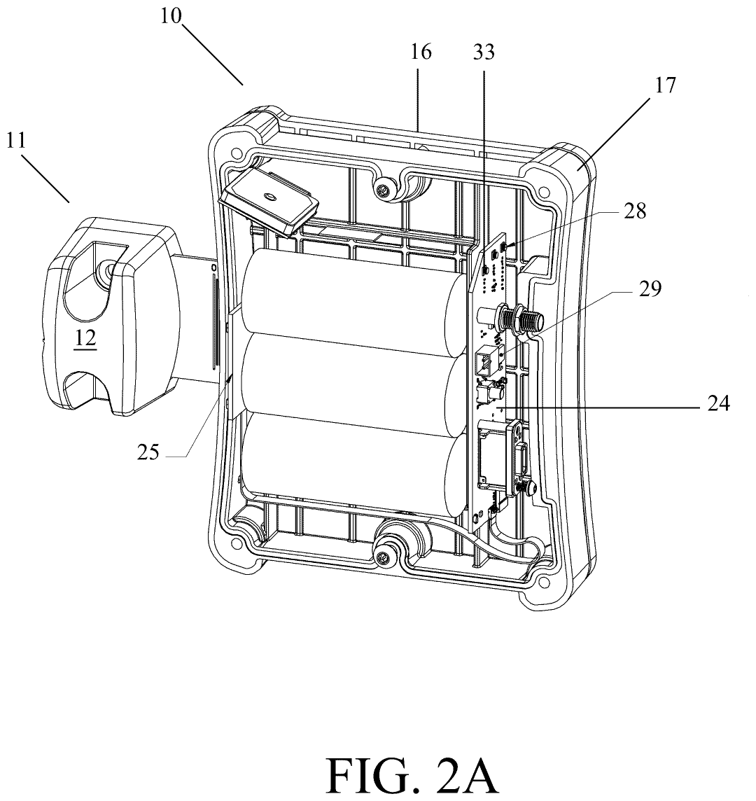

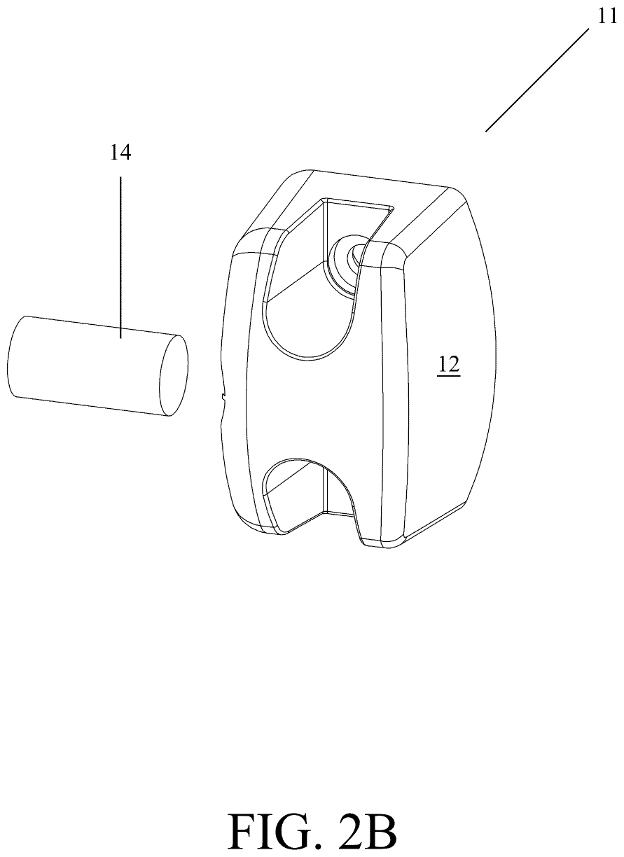

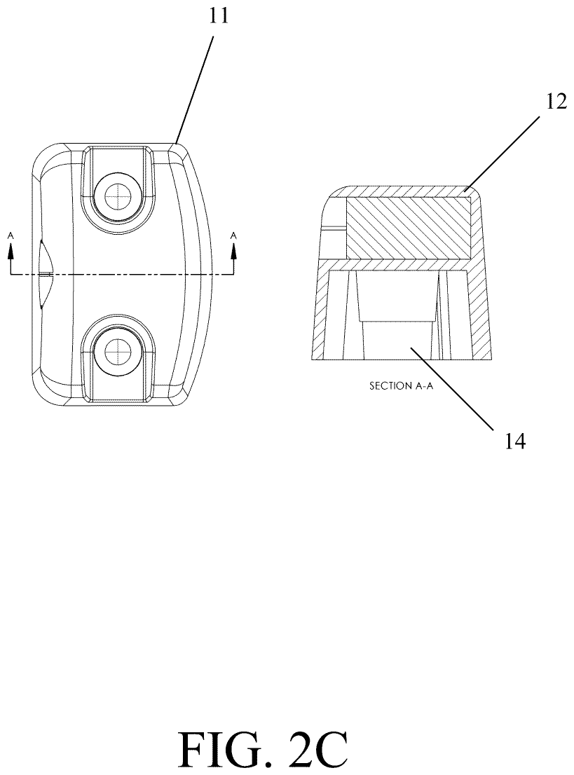

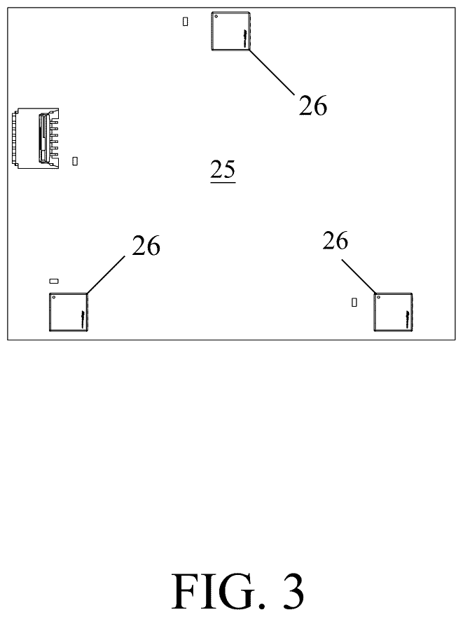

FIG. 2A shows the sensor 16 with the upper half of the housing 17 removed. FIG. 2A also shows the alignment tongue 22 that connects both the sensor bracket and the target bracket described below. The sensor housing 17 contains a first circuit board 24 featuring components such as a microprocessor 33, wireless module, charge controller and other components, including an antenna 28 and an internal storage device 29. The antenna 28 allows the deformation gauge 10 to transmit data to other devices and the internal storage device 29 allows the gauge 10 to store data. This is especially useful in the event of a power failure in which the data collected by the gauge 10 cannot be transmitted to another device for safekeeping—the internal storage device 29 can store that same data locally until it can be safely retrieved. There is also a second circuit board 25 that includes or features the magnetic sensor array 35 which in preferred embodiments and the anticipated best mode are three 3D Hall effect sensors 26 (see FIG. 3).

FIG. 2B shows the target housing 12 with the magnet 14 removed. The target housing 12 is made of a material that does not interfere, change or interact with the magnetic field created by the internal magnet 14. FIG. 2C shows a cross sectional view of the same target 11 showing the magnet 14 installed therein.

FIG. 3 shows the second circuit board 25 of this embodiment in more detail. In preferred embodiments and the inventor's anticipated best mode of the system, the magnetic sensors, i.e. the Hall effects sensors 26 are organized in a triangle on the second circuit board 25. That is, the sensors 26 are arranged on the second circuit board 25 at vertices of a projected triangle. In some implementations, the projected triangle is an equilateral triangle.

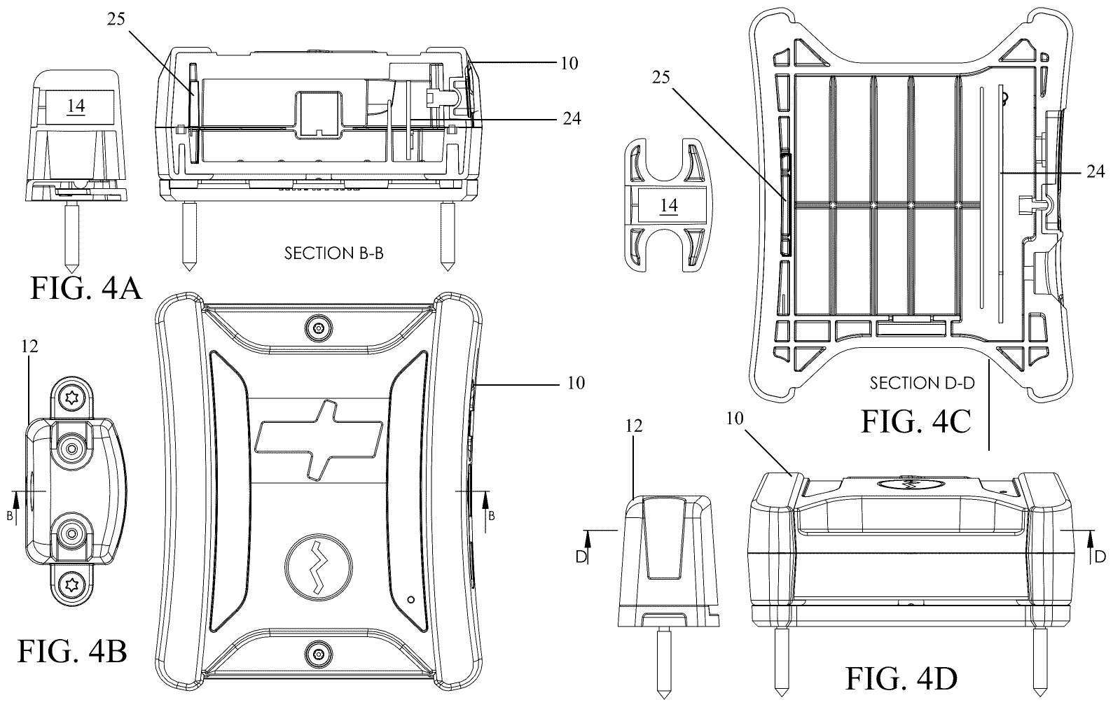

FIGS. 4A through 4D show the optimal positioning of the target magnet 14 with respect to the circuit board 25 that contains the magnetic field sensors 26. These figures show a cylindrical target magnet 14 with a longitudinal axis that is perpendicular or substantially perpendicular to the plane formed by the flat surface of the printed circuit board 25. This orientation maximizes the Hall effect experienced by the magnetic sensors 26.

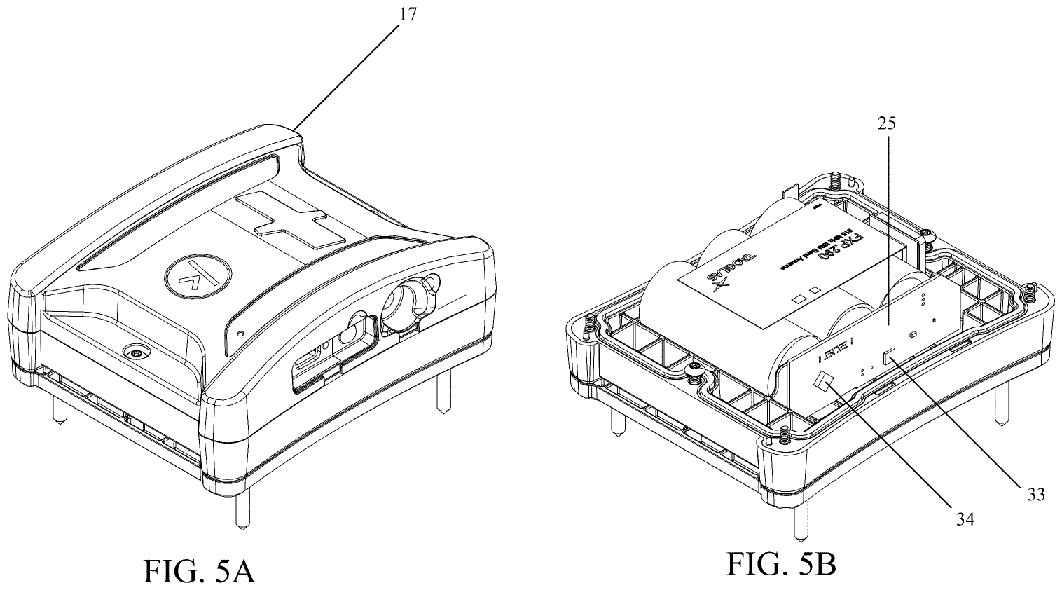

FIGS. 5A and 5B shows a tilt gauge 27 with the cover removed to expose its internal workings. The tilt gauge 27 includes at least one accelerometer 34 operably connected to a microprocessor 33. The inventor anticipates using the same sensor bracket 18 to mount a tilt gauge 27. A tilt gauge 27 contains one or more three dimensional MEMS accelerometers 34. A MEMS accelerometer 34 is able to measure the acceleration due to gravity in three dimensions to allow the meter to indicate the position of the tilt gauge. The tilt gauge 27 can be placed on the same structure the deformation gauge 10 is attached to in order to detect changes in the attitude or orientation of a structure in relation to the ground. The tilt gauge 27 can be used in conjunction with (or separately from) the deformation gauge to determine the movement of the entire structure rather than the movement around a defect in the structure. As shown in FIGS. 4C and 4D, the same housing can contain circuit boards 24, 25 that include (1) the magnetic field sensor array 35 and (2) the accelerometers that are integral to the tilt gauge 27.

As discussed above, the tilt gauge 27 uses an accelerometer 34 to detect changes in the orientation of the tilt gauge with respect to Earth's gravity. Preferred embodiments of the tilt gauge 27 include at least one high-precision accelerometer and may also include at least one low-precision accelerometer 34. The accelerometers 34 can be moved or vibrated by outside forces such as vehicles passing near the sensors. The measurements from the accelerometer(s) are sampled repeatedly over the course of small time increments-hundreds of times in less than a second as discussed above to average the measurements and “filter” the data to remove error or “noise.”

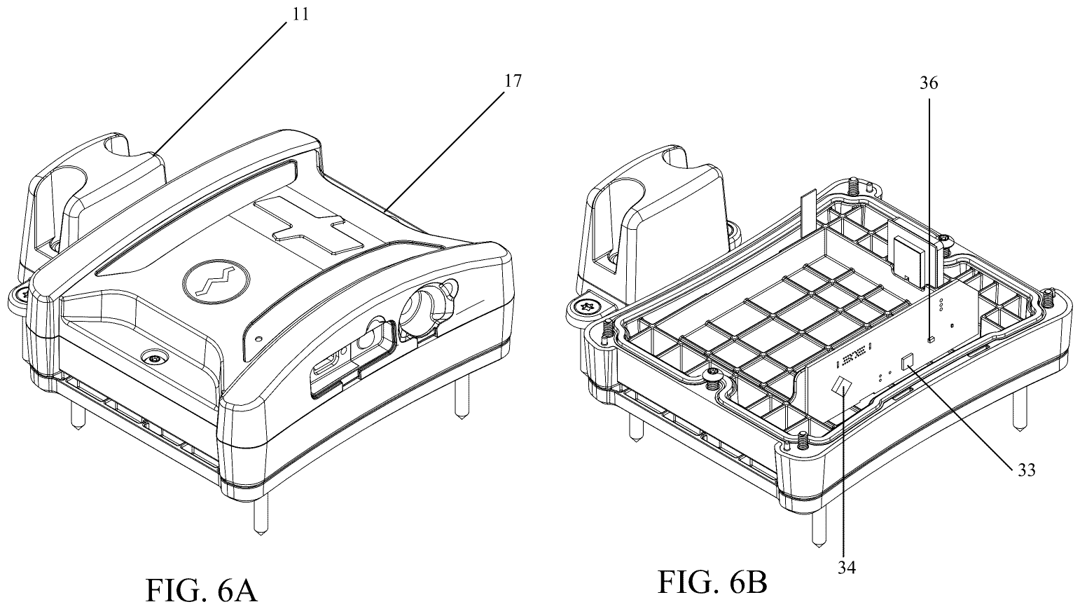

FIGS. 6A and 6B show another embodiment of the monitoring system. One or more temperature sensors 36 can be integrated into the deformation gauge 10 or the combined deformation 10 and tilt gauge 27 so that changes in temperature of the magnet, the hall-effect sensors and/or the accelerometer(s) can be monitored. As discussed previously, changes in temperature can affect the strength of the magnetic field produced by the target magnet 12 in known, calculable amounts. Prior to the system being placed into use, the magnetic field of the target magnet 12 is analyzed and mapped under different temperatures so that when readings are taken in real time, the measurements of the magnetic field sensors 26 can be used to accurately and precisely calculate the location of the target magnet 12 with respect to those sensors 26. Temperature sensor(s) can be used to monitor any of the individual components of the system and/or the temperature in the housing 17 itself to more accurately determine the position of the target magnet 12 to the sensor array 35.

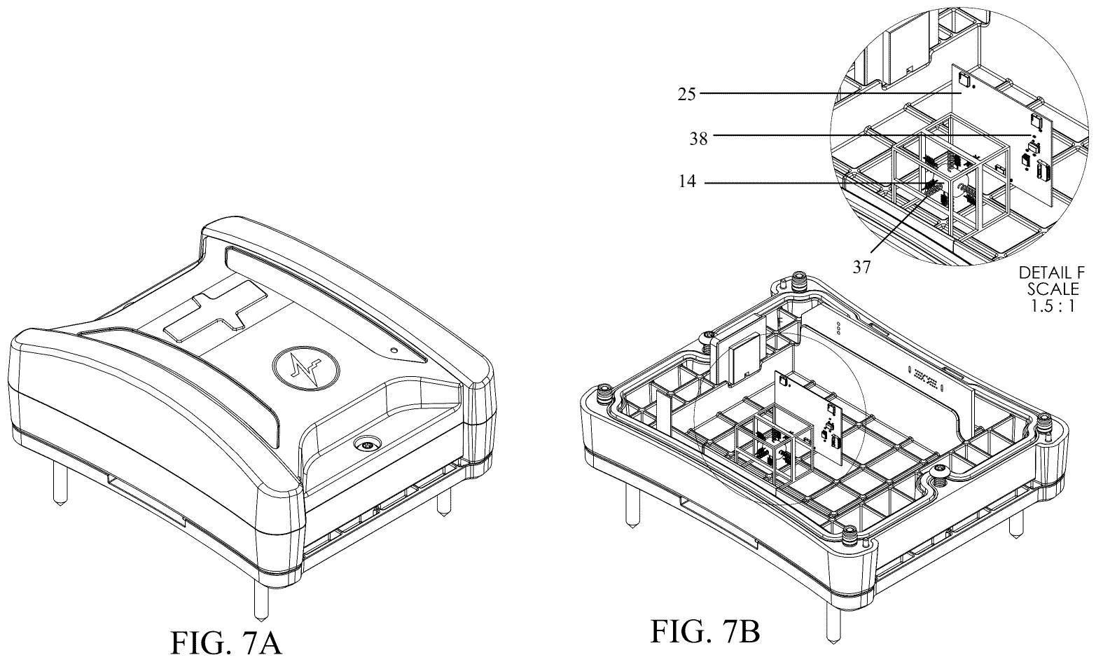

FIGS. 7A and 7B show yet another embodiment of the monitoring system that can be used to detect seismic activity. In this version of the deformation gauge 10 the target magnet 14 is suspended in three dimensions from a mounting spring 37 or set of mounting springs 37 or other dampening device. Seismic activity could easily cause the entire system to move all at once and in the same directions thereby preventing the system from detecting movement of an entire structure to which the gauge(s) are attached. However, suspending the target magnet 14 from one or more mounting springs 37 allows the magnetic field sensor array 35 to detect the movement of the target magnet 14 while it is suspended thereby allowing the system to capture changes in movement that would move the entire system, such as seismic activity. FIG. 7 also shows an optional microphone 38 that can be integrated into this version of the system. In addition to detecting vibrations due to seismic activity, this microphone detects additional reference data from a predetermined range of frequencies generated by the other components of the system. The data from the accelerometer 34 and magnetic sensor array 35 can be measured and then filtered to remove or filter lower frequency changes in position from higher frequency or short-frequency vibrations caused by seismographic vibrations.

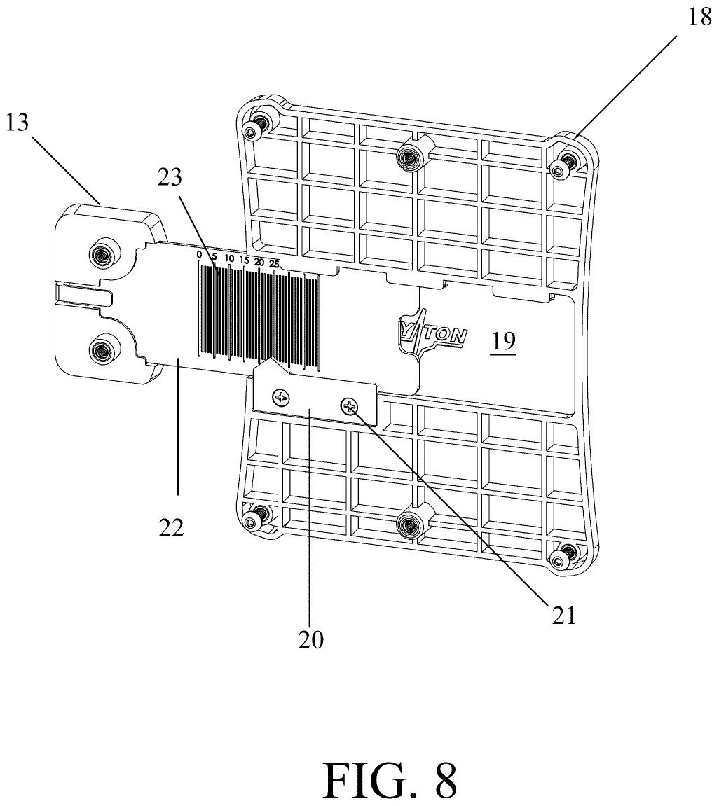

FIG. 8 shows the target bracket 13, sensor bracket 18 and the alignment tongue 22. The brackets 13, 18 and alignment tongue 22 are used to position the components of the gauge 10 in relation to the crack or other defect being measured. More specifically, the user first determines the mounting positions of each bracket 13, 18. Since the magnet 14 used in preferred embodiments is strong enough to saturate the hall effect sensors 26 if they are placed too close to the magnet 14, the user has to determine the placement of the target 11 relative to the sensor 16. This involves measuring the size or at least the width of a crack at the point at which the deformation gauge 10 will be placed. The user will need to space the target 11 apart from the sensor 16 so that if the structure to which the system is attached changes configuration brining the magnetic sensors 26 closer to the target magnet 12, the sensors 26 will not be saturated by the magnetic field nor will they be so far away from the target magnet 12 that they will not be effective detectors. In preferred embodiments and the inventor's anticipated best mode a cylindrical neodymium magnet 14 is placed in the target housing 12 and is placed a precalculated distance away from the Hall effect sensors 26 when in use. Preferred embodiments and the inventor's anticipated best mode of the device include a scale 23 on the alignment tongue 22 to allow the user to easily measure the distance between the sensor bracket 18 and target bracket 13 during installation.

The alignment tongue 22 is positioned in a groove 19 located on the sensor bracket 18. The alignment tongue 22 slides in and out of this groove 19. There is also a tab 20 that is positioned such that it overlaps a portion of the groove 19 and is thereby positioned above the alignment tongue 22. When the alignment tongue is extended away from the sensor bracket to position the target bracket 13, the tab 20 can be tightened using screws or other conventional fasteners such that the tab 20 is tightened against the alignment tongue 22 thereby locking it in to place.

Once the user has determined the desired distance between the target 11 and the sensor 16, the user mounts the target bracket 13 and the sensor bracket 18 to the surface featuring (including) the crack, gap, space, break or similar defect. The target bracket 13 logically goes on one side of the crack while the sensor bracket 18 is placed on the other side of the crack. First, the user determines the position of the sensor in relation to the crack and measures the crack or defect itself to determine where the target bracket will be placed. The target bracket 13 and the sensor bracket 18 are attached via an alignment tongue 22, an elongated structure that is attached to both the target bracket 13 and the sensor bracket 18. Once the position of both brackets is determined, the alignment tongue 22, which is slidably engaged with the sensor bracket 18, is extended away from the sensor bracket 18 the desired, calculated distance. The alignment tongue 22 is attached to the target bracket 13 at the end opposite the end attached to the sensor bracket 18. By extending the tongue, the user moves the target bracket 13 away from the sensor bracket 18. Next, the user, locks the alignment tongue 22 in place on the brackets. In preferred embodiments, the user tightens screws 21 that are positioned adjacent to the alignment tongue 22 such that tightening the screws 21 tightens the alignment tongue 22 in place. The brackets are physically attached to the wall via conventional fasteners or adhesives and the alignment tongue 22 is then retracted back into the sensor bracket 18. Next, the target 11 and the sensor 16 are mounted onto their respective brackets 13, 18 and the gauge 10 is ready for use.

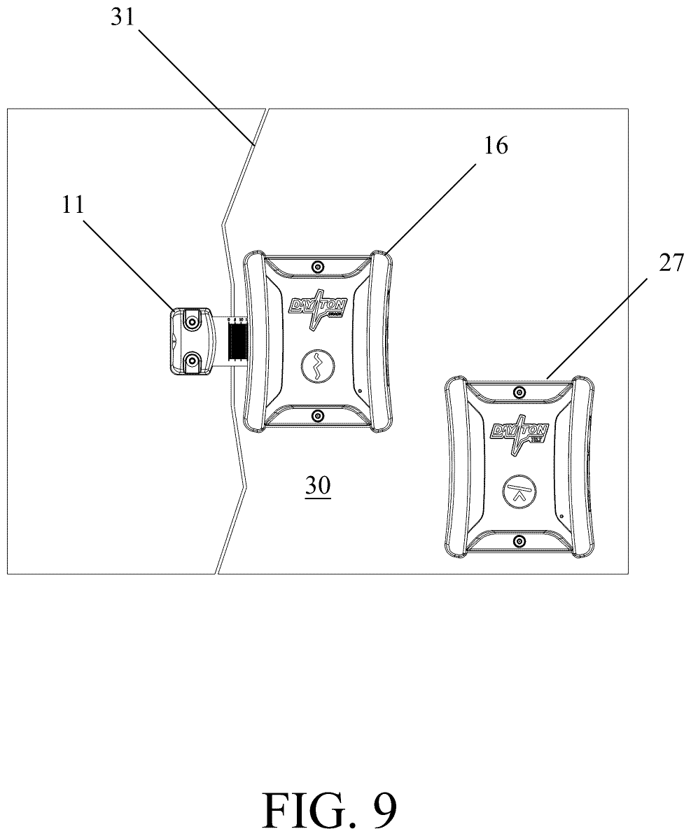

FIG. 9 shows one anticipated application of the system the gauges in place on a structure. The structure, a wall 30, features a crack 31 in it. The deformation gauge 10 has been placed such that the sensor 16 is on one side of the crack and the target 11 is on the other side of the crack. In addition, the same structure also has a tilt gauge 27 attached thereto. This configuration allows the user to monitor any change in the crack 31 or the tilt of the wall 30 remotely. Each gauge 10, 27 is operably connected to or includes a transmitter that is capable of transmitting the data collected by the gauge to an external storage device. Each gauge is also equipped with an electronic storage device that allows it to store measurements on or in the gauge itself. This allows the user to store the data collected over time and/or to retrieve data after the gauge has lost power or otherwise stopped functioning.

In broad embodiment, the present invention is a system for monitoring the condition of a structure remotely. The advantages of the present invention include, without limitation, the ability to remotely monitor changes in a crack or gap in a structure over time or in response to specific events without having to have line of sight to the gauge or having a technician available to physically examine the gauge. Moreover, the present method allows a user to monitor the changes in a crack or gap or the movement of structures in three dimensions rather than just one or two. Moreover, the inventive method also incorporates a tilt meter to allow the user to measure not only changes in a gap in a structure, but the orientation of the structure relative to the ground. Engineers and technicians working on a building, wall or bridge can remotely monitor the effects their work has on a gap or crack in a structure and/or the tilt or movement of the structure in three dimensions.
a. Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

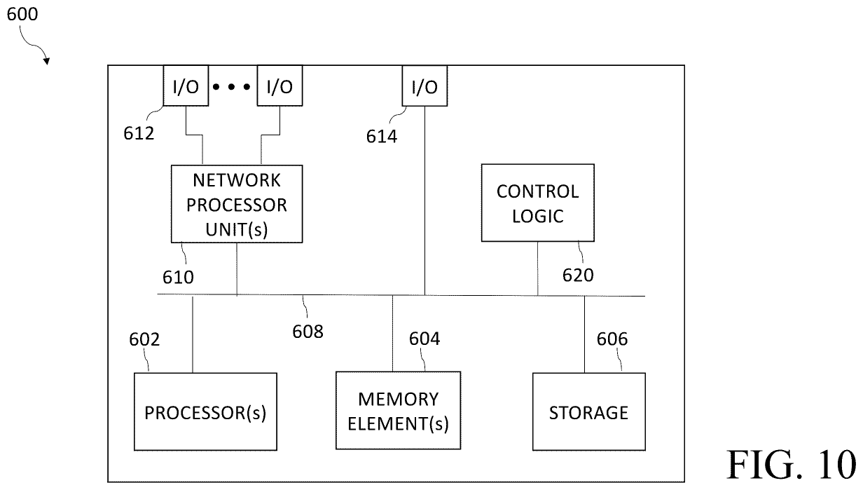

Referring to FIG. 10, FIG. 10 illustrates a hardware block diagram of a computing device 600 that may perform functions associated with operations discussed herein in connection with the techniques depicted in FIGS. 1-9. In various embodiments, a computing device or apparatus, such as computing device 600 or any combination of computing devices 600, may be configured as any entity/entities as discussed for the techniques depicted in connection with FIGS. 1-9, such as the microprocessor 33, in order to perform operations of the various techniques discussed herein.

In at least one embodiment, the computing device 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 and/or sensors to communicate in order to exchange information and/or data. Bus 608 can be implemented with any architecture designed for passing control, data and/or information between processors, memory elements/storage, peripheral devices, and/or any other hardware and/or software components that may be configured for computing device 600.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise wirelessly communicating data and/or information to another processor for monitoring data.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

### INDUSTRIAL APPLICABILITY

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Clause 1. A system for detecting changes in a structure comprising: a deformation gauge comprising: a target magnet for positioning at a predetermined location; and an array of magnetic sensors operably connected to a microprocessor, the microprocessor configured to determine a position of the target magnet based on one or more signals received from the array of magnetic sensors.

Clause 2. The system of clause 1, wherein the array of magnetic sensors are positioned at vertices of an projected triangle and are attached to a single circuit board.

Clause 3. The system of clause 2, wherein the target magnet is positioned so a magnetic field of the target magnet is substantially perpendicular to a flow of current in a conductor of the array of magnetic sensors.

Clause 4. The system of clause 3, further comprising a tilt gauge for determining an angular displacement of the structure in three dimensions, the tilt gauge comprising a three-axis accelerometer operably connected to the microprocessor.

Clause 5. The system of clause 1, further comprising a tilt gauge comprising a three-axis accelerometer operably connected to the microprocessor for determining an angular orientation of the structure.

Clause 6. The system of clause 5, further comprising a temperature sensor operably connected to measure a temperature of the system.

Clause 7. The system of clause 6, wherein the microprocessor is further configured to determine a position of the target magnet further based on the temperature of the system

Clause 8. The system of clause 2, wherein the array of magnetic sensors are hall-effect sensors; and the projected triangle is an equilateral triangle.

Clause 9. The system of clause 1, further comprising a low-frequency microphone operably connected to the microprocessor for measuring vibrations.

Clause 10. The system of clause 9, further comprising a mounting spring operatively coupled to the target magnet, the mounting spring is configured to suspend the target magnet from the structure.

Clause 11. The system of clause 1, further comprising a mounting plate configured to position the target magnet at the predetermined location, wherein the predetermined location is determined with respect to the array of magnetic sensors.

Clause 12. A system for detecting changes in a structure comprising: a deformation gauge comprising: a sensor array comprising: three 3-dimensional magnetic sensors triangularly arranged in a single plane; wherein the sensor array is operably connected to a microprocessor; a target magnet having a magnetic field that is positioned substantially perpendicular to the plane in which the magnetic sensors are arranged; wherein the microprocessor is configured to detect changes in a distance of each sensor relative to the target magnet to determine changes of the position of the target magnet in three dimensions; and a tilt gauge comprising: a plurality of three-axis accelerometers operably connected to the microprocessor that is also equipped with software that interprets data from the plurality of three-axis accelerometers to detect changes in the position in 3 dimensions of the plurality of three-axis accelerometers in relation to Earth's gravity.

Clause 13. The system of clause 12, further comprising a temperature sensor operably connected to measure a temperature of the system, the temperature sensor operably connected to the microprocessor, the microprocessor configured to calculate changes in magnetic field strength of the target magnet caused by temperature fluctuation and to compensate for measurements taken by the sensor array and the plurality of three-axis accelerometers caused by temperature fluctuation.

Clause 14. The system of clause 12, further comprising a mounting spring operatively coupled to the target magnet, the mounting spring is configured to suspend the target magnet from the structure.

Clause 15. The system of clause 14, further comprising a low-frequency microphone operably connected to the microprocessor, the low-frequency microphone configured to measure low-frequency vibrations of the structure, components of the sensor array, and/or the plurality of three-axis accelerometers.

Clause 16. The system of clause 15, further comprising a high-frequency microphone operably connected to the microprocessor, the high-frequency microphone configured to measure high-frequency vibrations of the structure, components of the sensors, and/or the plurality of three-axis accelerometers.

Clause 17. A method of detecting changes a structure, the method comprising: disposing an array of magnetic sensors onto the structure; disposing a target magnet on the structure at a predetermined position relative to the array of magnetic sensors; calibrating the array of magnetic sensors based on the position of the target magnet; monitoring, via microprocessors, one or more signals from the array of magnetic sensors indicative of a magnetic field generated by the target magnet; and determining, via a microprocessor, a change in position of the target magnet based on the monitoring.

Clause 18. The method of clause 17, further comprising detecting an ambient temperature via a temperature sensors; wherein the determining the change in position of the target magnet is further based on the detected ambient temperature.

Clause 19. The method of clause 17, wherein the disposing the target magnet on the structure comprises: aligning the target magnet with the array of magnetic sensors via an alignment tongue; mounting the target magnet to the structure; removing the alignment tongue from the target magnet.

Clause 20. The method of clause 17, wherein the array of magnetic sensors comprises three magnetic sensors substantially equidistantiy disposed from one another.

We claim:

1. A system for detecting changes in a structure comprising:
a deformation gauge comprising:
a target magnet for positioning at a predetermined location; and
an array of magnetic sensors operably connected to a microprocessor, the microprocessor configured to determine a position of the target magnet based on one or more signals received from the array of magnetic sensors.

2. The system of claim 1, wherein the array of magnetic sensors are positioned at vertices of an projected triangle and are attached to a single circuit board.

3. The system of claim 2, wherein the target magnet is positioned so a magnetic field of the target magnet is substantially perpendicular to a flow of current in a conductorin the array of magnetic sensors.

4. The system of claim 3, further comprising a tilt gauge for determining an angular displacement of the structure in three dimensions, the tilt gauge comprising a three-axis accelerometer operably connected to the microprocessor.

5. The system of claim 1, further comprising a tilt gauge comprising a three-axis accelerometer operably connected to the microprocessor for determining an angular orientation of the structure.

6. The system of claim 5, further comprising a temperature sensor operably connected to measure a temperature of the system.

7. The system of claim 6, wherein the microprocessor is further configured to determine a position of the target magnet further based on the temperature of the system

8. The system of claim 2, wherein the array of magnetic sensors are hall-effect sensors; and the projected triangle is an equilateral triangle.

9. The system of claim 1, further comprising a low-frequency microphone operably connected to the microprocessor for measuring vibrations.

10. The system of claim 9, further comprising a mounting spring operatively coupled to the target magnet, the mounting spring is configured to suspend the target magnet from the structure.

11. The system of claim 1, further comprising a mounting plate configured to position the target magnet at the predetermined location, wherein the predetermined location is determined with respect to the array of magnetic sensors.

12. A system for detecting changes in a structure comprising:
a deformation gauge comprising:
a sensor array comprising: three 3-dimensional magnetic sensors triangularly arranged in a single plane;
wherein the sensor array is operably connected to a microprocessor;
a target magnet having a magnetic field that is positioned substantially perpendicular to the plane in which the magnetic sensors are arranged;
wherein the microprocessor is configured to detect changes in a distance of each sensor relative to the target magnet to determine changes of the position of the target magnet in three dimensions; and
a tilt gauge comprising:
a plurality of three-axis accelerometers operably connected to the microprocessor that is configured to interpret data from the plurality of three-axis accelerometers to detect changes in the position in 3 dimensions of the plurality of three-axis accelerometers in relation to Earth's gravity.

13. The system of claim 12, further comprising a temperature sensor operably connected to measure a temperature of the system, the temperature sensor operably connected to the microprocessor, the microprocessor configured to calculate changes in magnetic field strength of the target magnet caused by temperature fluctuation and to compensate for measurements taken by the sensor array and the plurality of three-axis accelerometers caused by temperature fluctuation.

14. The system of claim 12, further comprising a mounting spring operatively coupled to the target magnet, the mounting spring is configured to suspend the target magnet from the structure.

15. The system of claim 14, further comprising a low-frequency microphone operably connected to the microprocessor, the low-frequency microphone configured to measure low-frequency vibrations of the structure, components of the sensor array, and/or the plurality of three-axis accelerometers.

16. The system of claim 15, further comprising a high-frequency microphone operably connected to the microprocessor, the high-frequency microphone configured to measure high-frequency vibrations of the structure, components of the sensors, and/or the plurality of three-axis accelerometers.

17. A method of detecting changes a structure, the method comprising:
disposing an array of magnetic sensors onto the structure;
disposing a target magnet on the structure at a predetermined position relative to the array of magnetic sensors;
calibrating the array of magnetic sensors based on the position of the target magnet;
monitoring, via microprocessors, one or more signals from the array of magnetic sensors indicative of a magnetic field generated by the target magnet; and
determining, via a microprocessor, a change in position of the target magnet based on the monitoring.

18. The method of claim 17, further comprising detecting an ambient temperature via a temperature sensors; wherein the determining the change in position of the target magnet is further based on the detected ambient temperature.

19. The method of claim 17, wherein the disposing the target magnet on the structure comprises:
aligning the target magnet with the array of magnetic sensors via an alignment tongue;
mounting the target magnet to the structure;
removing the alignment tongue from the target magnet.

20. The method of claim 17, wherein the array of magnetic sensors comprises three magnetic sensors substantially equidistantly disposed from one another.
